(19) United States
(12) Patent Application Publication
(10) Pub. No.: US 2007/0164585 A1
(43) Pub. Date: Jul. 19, 2007

(54) VEHICLE PILLAR GARNISH MOUNTING STRUCTURE

(76) Inventors: Minoru Hasegawa, Chiryu-shi (JP); Keisuke Shimizu, Kariya-shi (JP); Yutaka Saguchi, Anjyo-shi (JP); Izuru Sugiura, Kariya-shi (JP); Yuuki Aoshima, Toyohashi-shi (JP)

Correspondence Address: MILES & STOCKBRIDGE PC, 1751 PINNACLE DRIVE, SUITE 500, MCLEAN, VA, 22102-3833, US

(21) Appl. No.: 11/564,009

(22) Filed: Nov. 28, 2006

(30) Foreign Application Priority Data
Nov. 28, 2005 (JP) 2005-342008

(51) Int. Cl. B60J 7/00

(52) U.S. Cl. 296/193.06

(57) ABSTRACT

A vehicle pillar garnish mounting structure has upper and lower retainers attached to the pillar. The pillar garnish has side edge flanges that are engaged with engagement parts at corresponding sides of the retainers. The retainers have an elongated block shape with U-shaped cross-section. The lower retainer has a hook unit that engages a cooperating part on a side edge flange of the pillar garnish to secure the pillar garnish to the hook unit.

### CROSS REFERENCE TO RELATED APPLICATION

This application claims the benefit of Japanese Patent Application 2005-342008 filed Nov. 28, 2005, incorporated herein by reference.

### BACKGROUND OF THE INVENTION

This invention relates to a mounting structure for a pillar garnish for covering the outer surface of a vehicle pillar.

Conventionally, in automobiles, the outer surfaces of the front pillars are covered with pillar garnishes, made so as to attractively cover and hide the parts where the outer surfaces of the front pillars and the side edges of the windshield are bonded to the side edges thereof. See, for example, unexamined Japanese Patent Application No. 2002-283932 (Patent Literature 1).

This type of pillar garnish is configured by a long thin molded piece of a synthetic resin or a long molded piece of thin metal sheet, and is fastened to the outer surface of the pillar at prescribed intervals at a plurality of locations along the longitudinal dimension of the back surface thereof. FIG. 9 shows a typical conventional mounting structure for a synthetic resin pillar garnish, wherein synthetic resin clips 9 having elastic fastening pawls 90 in the tips thereof are provided in a seating face on the back side of a pillar garnish 1, those clips 9 are pressed into engagement holes 29 provided in the outer panel of the pillar 2, and the elastic fastening pawls 90 are fastened at the circumferential edges of the engagement holes 29.

FIG. 8 shows a typical mounting structure for a pillar garnish comprising a metal sheet. In the pillar garnish 1, side edge flanges 11 protrude toward the pillar side, and engagement holes 12 are provided in the side edge flanges 11. In the pillar 2, corresponding to the side edge flanges 11, synthetic resin clips 7 are mounted to the pillar outer surface. The clips 7 have substantially L-shaped cross sections, the base parts 70 of which are riveted to the pillar outer surface. Engagement surfaces 71 bend and rise from the end edges of the base parts 70. In the tips thereof, fastening projections 72 are formed, capable of mating in the engagement holes 12. Also, in the engagement surfaces 71, at positions alternating with the fastening projections 72, elastic clamping pieces 73 are provided, adjacent to and facing the engagement surfaces 71. The pillar garnish 1 is made so that the side edge flanges 11 are pushed in between the elastic clamping pieces 73 and the engagement surfaces 71 of the clips 7, the engagement holes 12 are mated with and fastened to the fastening projections 72, and, together therewith, by the elastic clamping pieces 73, the side edge flanges 11 are moved close to the engagement surface 71 side, and the fastening condition of the engagement holes 12 and fastening projections 72 is maintained.

Now, with a conventional mounting structure, the side edge of the pillar garnish 1 is fastened, one side at a time, by separate engagement means 7 and 9 or the like. Therefore, the pulling rigidity in the width dimension of the pillar garnish 1 is not sufficient, and, with a front pillar 2 configuring the front edge of the door opening, a passenger will sometimes place a hand there when entering or exiting the vehicle and the pillar garnish 1 covering the pillar outer surface flexes, a tendency that is particularly great with pillar garnishes 1 comprising a thin metal sheet. When the pillar garnish 1 is repeatedly flexed, looseness or wobble occurs between the pillar 2 and the fasteners, the fasteners readily become disengaged, and there is a danger of the pillar garnish 1 separating when subjected to strong wind pressure when the vehicle is traveling at high speed.

### BRIEF DESCRIPTION OF THE INVENTION

The present invention was devised to provide a pillar garnish mounting structure wherewith the pulling rigidity of the pillar garnish is strengthened, flexure does not readily occur, and, because of that, the fasteners are prevented from disengaging due to loosening or wobble between the pillar and the fasteners.

In one embodiment, the present invention is a vehicle pillar garnish mounting structure for fastening a pillar garnish, for covering the outer surface of a vehicle pillar, to the outer surface of the pillar, by engagement means, wherein: side edge flanges are formed in the two side edges, in the width dimension, of the pillar garnish, bending away from those side edges and extending outward toward the pillar side; a retainer is secured to the outer surface of the pillar, comprising engagement parts for fastening the two side edge flanges of the pillar garnish, respectively, to the two sides in the width dimension, as the engagement means; and the side edge flanges on the two sides of the pillar garnish are engaged in engagement parts on the two sides of the retainer. By using a retainer that comprises fasteners on both sides, the pulling rigidity in the width dimension of the pillar garnish can be strengthened, and mounting can be done in a stable condition that strongly resists flexure.

In the embodiment, the retainer is configured by an integrally molded product, of a synthetic resin, having a substantially U-shaped cross section, with an upper surface part facing the back surface of the pillar garnish, and side surface parts respectively bending away from the two side edges in the width dimension of that upper surface part and extending downward, made so as to be secured to the pillar outer surface by mounting parts formed on the back surface side of the retainer. The engagement parts are formed in the two side surface parts, integrally therewith. Fasteners are formed using side surface parts, so there is great freedom in designing the fasteners.

In one side surface part of the retainer, as one of the engagement parts, a fastening projection mates in an engagement hole formed in one side edge flange of the pillar garnish protruding from that side surface part, and an elastic clamping piece extends from the one side surface part, for clamping one side edge flange of the pillar garnish with that side surface part. In the other side surface part of the retainer, as one of the engagement parts, an elastic fastening piece is provided, extending diagonally downward and outward from that side surface part, in a tongue shape, the lower end whereof engages with the end edge of the other side edge flange of the pillar garnish. The garnish is mounted to one side with a fastening projection and a clamping piece, so movement of the garnish in the up-and-down and width directions is restricted.

The fastening projection protrudes in a pawl shape, oriented diagonally downward and outward from the one side surface part. The elastic clamping piece is formed substantially in an L-shape, extending and bending outward from the one side surface part and extending upward along the one side surface part. The fastening projection and the elastic clamping piece are deployed in parallel so as to be mutually adjacent to the one side surface part. The elastic fastening piece is made to have a structure which extends in cut-and-raised form from the other side surface part. The pillar garnish is easily mounted by pushing in the side edge flanges on the two sides thereof from above along the side surface parts on the two sides of the retainer.

In another retainer, from the lower end of a main body thereof, a hook unit is extended, the upper ends whereof are open, and the inner ends whereof, bending from that open part and extending toward the main body, are closed. At a position corresponding to the hook unit in the back surface of the pillar garnish, a fastener having a laterally oriented pin is provided, along the width dimension of the retainer. The pin is mated in a channel in the retainer and made to fasten in the inner ends of the channel. Even should looseness or wobble occur in the fasteners, they will not become disengaged due to wind pressure pushing up from below when traveling at high speed.

### BRIEF DESCRIPTION OF THE DRAWINGS

The invention will be further described in conjunction with the accompanying drawings, which illustrate preferred (best mode) embodiments, and wherein:

FIG. 1 is a fragmentary view of a pillar garnish for covering the outer surface of a front pillar in a vehicle.

FIG. 2 is a section along the II-II line in FIG. 1 and FIG. 3.

FIG. 3 is a perspective view of a retainer used in the mounting structure of the present invention.

FIG. 4 is an exploded perspective view of another retainer, having a hook part, used in a mounting structure of the present invention, and a latching piece engaging the hook part.

FIG. 5 is a section at a position along the V-V line in FIG. 4, showing the condition wherein the hook part and latching piece noted above are engaged.

FIG. 6 is a fragmentary side elevation showing the latching action of the hook part and latching piece.

FIG. 7 is a section of a mounting structure at a position along the VII-VII line in FIG. 1.

FIG. 8 is a section at a position along the VIII-VIII line in FIG. 1, showing a typical mounting structure for a pillar garnish.

FIG. 9 is a section of another conventional pillar garnish mounting structure.

### DETAILED DESCRIPTION OF THE INVENTION

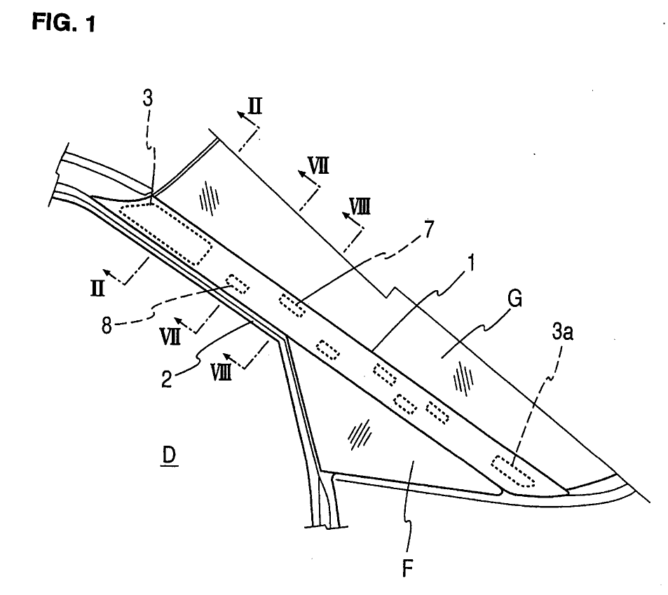

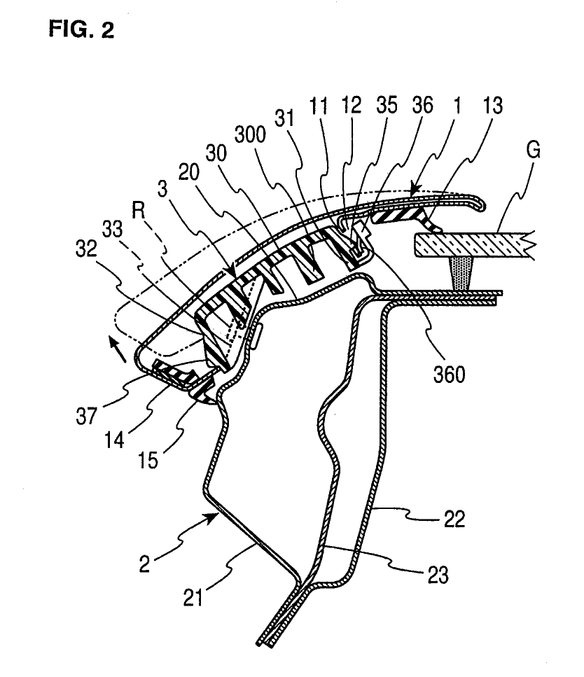

One embodiment wherein the present invention is applied to the mounting of a pillar garnish 1 for covering the outer surface of a front pillar 2 along the side edge of a windshield G, as shown in FIG. 1 and FIG. 2, is now described. In the front pillar 2, which effects a closed cross section with an outer panel 21, inner panel 22, and reinforcement 23, on the center side of the vehicle body, one end edge where the side edges of the two panels 21 and 22 and the reinforcement 23 are joined configures a front window opening side edge, and, to the outer surface of that end edge, the side edge of the windshield G is bonded with an adhesive. The other end edge of the front pillar 2 forms the front edge of a fixed window F and front door D opening at a position on the vehicle body side surface side. Also, a pillar outer surface 20 from the windshield G side junction to the vehicle body side surface side is covered by the pillar garnish 1.

In the embodiment, the pillar garnish 1 is a press-molded product comprising a long metal panel that extends along the pillar outer surface 20. The upper end and lower end thereof are fastened by retainers 3 and 3a provided in the pillar outer surface 20, while the middle part along the longitudinal dimension is fastened and secured to the pillar outer surface 20 by engagement means 7 and 8.

As shown in FIG. 2, the end edge of the pillar garnish 1 on the windshield G side has a double structure wherein the panel terminus is folded back to the back surface side along the entire length in the longitudinal dimension, and the folded-back end bends so as to protrude from the back surface side noted above toward the pillar outer surface 20, whereupon a side edge flange 11 is formed. In the side edge flange 11, at prescribed intervals along the longitudinal dimension, angular engagement holes 12 are formed. On the back surface side of the double structure noted above, a sealing member 13 is provided for filling up the gap with the windshield G.

In the end edge of the pillar garnish 1 on the vehicle body side surface side, over the entire length in the longitudinal dimension, a side edge flange 14 is formed which is bent toward the pillar outer surface 20 side to form a substantially v-shaped cross section, and a sealing member 15 is provided in the side edge flange 14 for filling up the gap with the pillar outer surface 20.

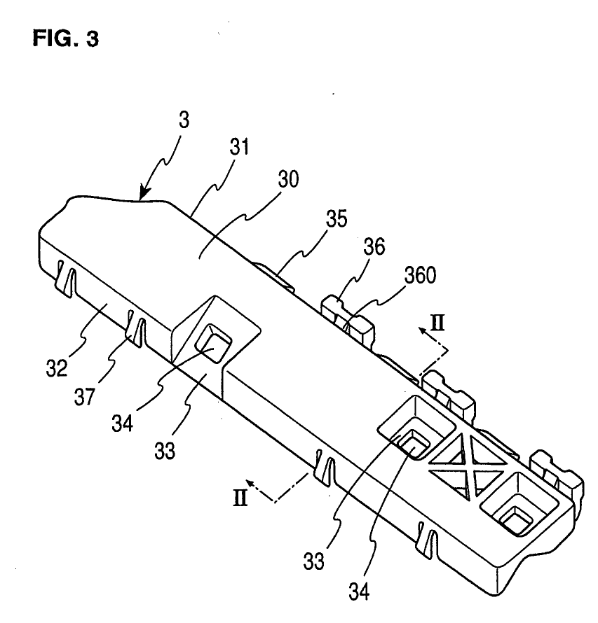

As shown in FIG. 2 and FIG. 3, the retainer 3 for fastening the upper end of the pillar garnish 1 is a molded product of a synthetic resin, which forms a long generally rectangular block shape along the pillar outer surface 20, the lateral width whereof is matched with the lateral width between the two side edge flanges 11 and 14 on the pillar garnish 1 back surface side. The retainer 3 has a substantially U-shaped shallow cross section with an upper surface part 30 which will face the back surface of the pillar garnish 1, and side surface parts 31 and 32 on the two sides, bent and protruding downward from the two side edges of the upper surface part 30. In the back surface of the upper surface part 30, reinforcing ribs 300 protrude downward therefrom.

In the retainer 3, concave mounts 33 are formed in the upper surface part 30. The mounts 33 are superimposed on the pillar outer surface 20, and joined to the pillar outer surface 20 by rivets R that pass through throughholes 34 in the mounts 33.

In the side surface part 31 of the retainer 3 on the vehicle body center side, at prescribed intervals in the longitudinal dimension of the side surface part 31, fastening projections 35 protrude toward the vehicle body center side, in correspondence with the engagement holes 12 in the side edge flange 11, as engagement parts for fastening the side edge flange 11 of the pillar garnish 1. Each fastening projection 35 is formed in the shape of a pawl having a vertical cross section that is substantially right-triangular, the outer surface whereof is a sloping surface, and the lower surface whereof is made an orthogonal surface relative to the side surface part 31. In the fastening projection 35, moreover, projecting side surfaces on both sides thereof are tapered so that the lateral width dimension of the tip part becomes narrow.

In the side surface part 31, moreover, at positions alternating with the fastening projections 35, there are elastic clamping pieces 36 for clamping the side edge flange 11 of the front pillar 2 with the side surface part 31, facing the side surface part 31 and in proximity therewith at a prescribed interval. Each elastic clamping piece 36 has a substantially L-shaped cross section, with a base end part extending from the lower-edge of the side surface part 31 toward the vehicle body center side, and a vertical piece that bends upward from that base end part and extends in parallel with the side surface part 31. In each of the elastic clamping pieces 36, moreover, is formed a tongue-shaped elastic contact 360, cut and raised diagonally, from the upper edge of the vertical pieces described above, diagonally downward on the side surface part 31 side.

In the side surface part 32 of the retainer 3, on the vehicle body outer side, there are elastic fastening pieces 37, at prescribed intervals in the longitudinal dimension of the side surface part 32, as engagement parts for fastening the side edge flange 14 of the pillar garnish 1. In each elastic fastening piece 37, the two side edges thereof are cut away from the side surface part 32 by a pair of parallel slits, and the elastic fastening piece 37 protrudes in a tongue shape extending diagonally downward and outward from the upper end of the side surface part 32. The tip of the elastic fastening piece 37 has a step for engaging the tip edge of the side edge flange 14 of the pillar garnish.

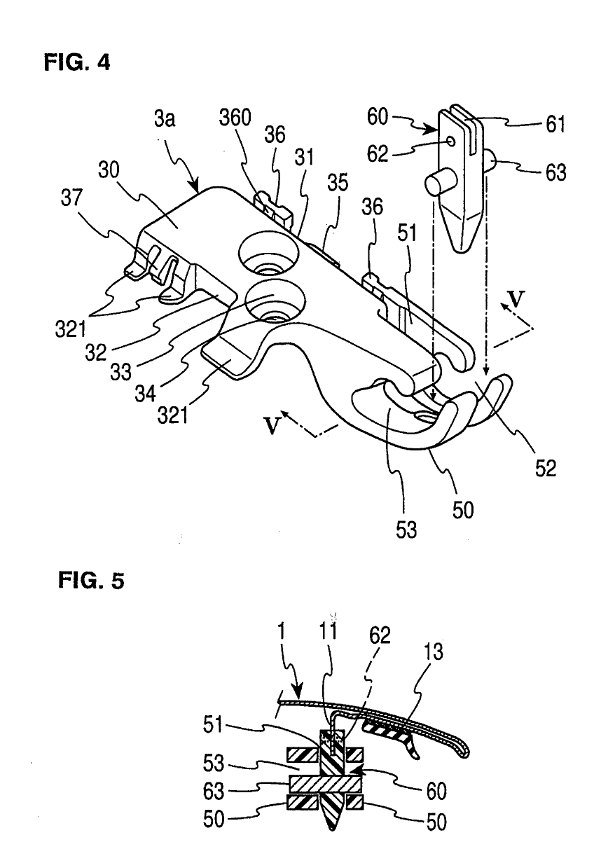

As shown in FIGS. 4 to 6, a retainer 3, which supports the lower end of the pillar garnish 1 has an integral hook part 50 extending from the lower end. The retainer 3a, in like manner as the upper end retainer 3, has a long generally rectangular block shape and comprises an upper surface part 30 and side surface parts 31 and 32 on the two sides thereof. In the side surface part 31 on the vehicle body center side, there are a fastening projection 35 and an elastic clamping piece 36 comprising a contact 360. In the side surface part 32 on the vehicle body outer side, there are an elastic fastening piece 37 and a plurality of contact flanges 321 to contact the pillar outer surface.

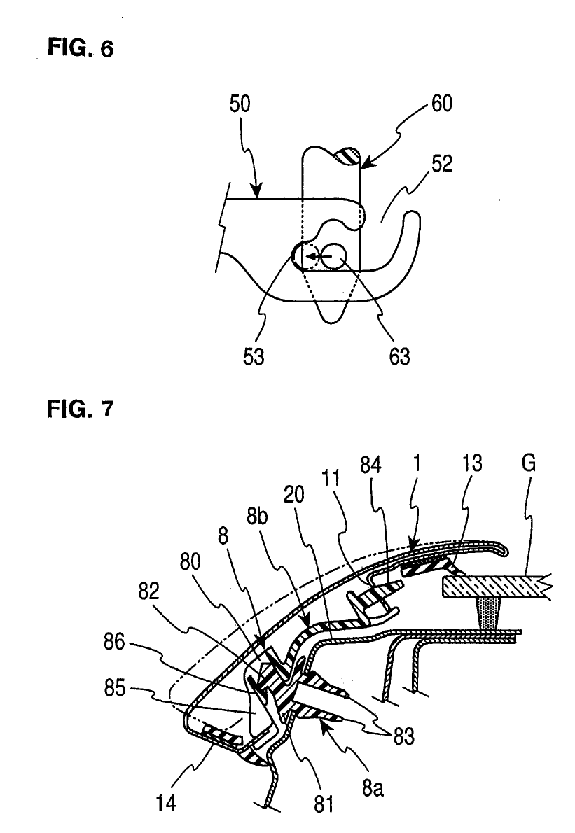

The hook part 50 is bifurcated to provide two forks separated across a prescribed interval by a slit 51 provided at an intermediate position in the width dimension. The hook part 50 has an opening 52 leading to a channel 53, the inner end whereof is closed, as shown in FIG. 6. The retainer 3a is joined to the pillar outer surface 20 by rivets which pass through throughholes 34 in a plurality of concave mounts 33 in the upper surface part 30.

In correspondence with the hook part 50 of the retainer 3a, at the lower end of the back side of the pillar garnish 1, there is a latching piece 60 of a synthetic resin, protruding outward toward the pillar side. The latching piece 60 has a slit 61 in the upper end thereof, which is mated with the side edge flange 11 of the pillar garnish 1, and is joined to that side edge flange 11 by a rivet 62 which passes through the upper end of the latching piece 60 and the side edge flange 11. Also, on the protruding end of the latching piece 60, there is a rod-shaped pin 63 that matches the width dimension of the hook part 50 of the retainer 3a, and that is laterally oriented with two ends that protrude from the two sides of the latching piece 60.

As shown in FIG. 2, FIG. 5, and FIG. 6, in order to fasten the pillar garnish 1, to the pillar outer surface 20, first of all, the latching piece 60 at the lower end of the back surface of the pillar garnish is inserted into the slit 51 of the hook part 50 from the vehicle outer side, so that the two ends of the pin 63, are inserted into the channel 53 from the opening 52 of the hook part 50. Then, the pillar garnish 1 is positioned so as to cover the entire surface of the pillar outer surface 20, and the engagement holes 12 in the side edge flange 11 of the pillar garnish 1 arid the fastening projections 35 of the retainers 3 and 3a are lined up. When that is being done, the channel 53 of the latching piece 60 is positioned in the portion of slightly wider channel width formed to the front at the inner end inside the channel 53, before being moved as shown by the arrow in FIG. 6, and does not interfere with the circumferential wall of the channel 53.

Then, the pillar garnish 1 is pressed toward the pillar outer surface 20 side from the vehicle outer side, one of the side edge flanges 11 is pressed into the gap between the side surface parts 31 of the upper and lower retainers 3 and 3a, on the one hand, and the elastic clamping pieces 36, on the other, and the fastening projections 35 are mated with and fastened to the engagement holes 12. With the engagement holes 12 and the fastening projections 35 engaged, the contacts 360 of the elastic clamping pieces 36 will contact the side edge flange 11, causing the flange to move closer toward the side surface part 31 side, and, thereby, the engaged condition between the fastening projections 35 and the engagement hole 12 is maintained.

As a consequence of the pressing described above, at the side of the other side edge flange 14 of the pillar garnish 1, the end edge of the side edge flange 14 will flex the elastic fastening pieces 37 of the side surface parts 32 of the upper and lower retainers 3 and 3a and, while so doing, fasten with the steps at the tips of the elastic fastening pieces 37.

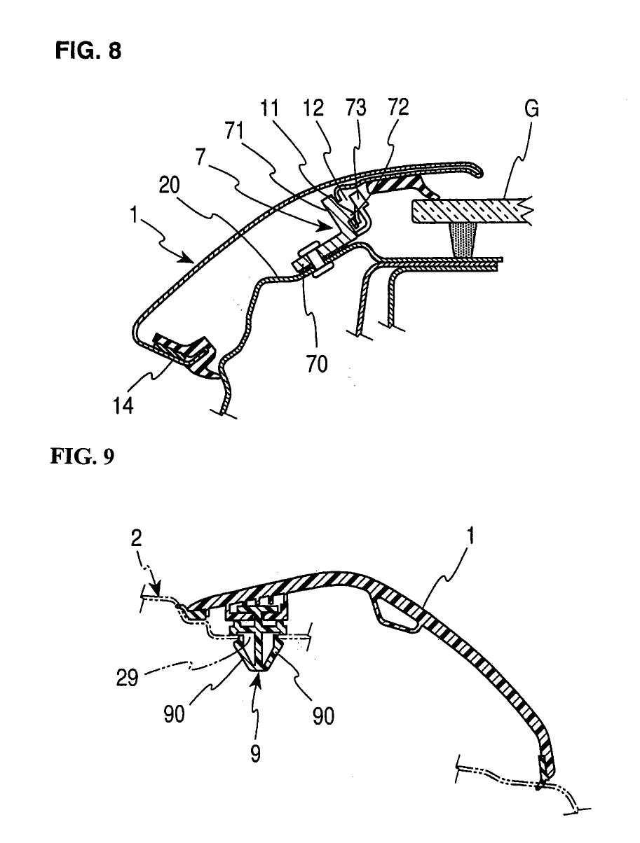

For the engagement means for mounting the intermediate portion of the side edge flange 11 of the pillar garnish 1 to the pillar outer surface 20, a synthetic resin clip 7 is used, in like manner as with the conventional structure, as shown in FIG. 8. Furthermore, the engagement parts provided in the engagement surfaces 71 rising from the pillar outer surface 20 have a structure like that of the engagement parts of the side surface part 31 of the retainer 3, comprising fastening projections 72 protruding from the engagement surfaces 71, and elastic clamping pieces 73. As a consequence of the pressing described earlier, the side edge flange 11 of the pillar garnish 1 is pressed in between the engagement surfaces 71 and the elastic clamping pieces 73, the engagement holes 12 are mated with and fastened to the fastening projections 72, and, together therewith, the side edge flange 11 is moved closer to the engagement surface 71 side by the elastic clamping pieces 73, whereupon the fastened condition between the engagement holes 12 and the fastening projections 72 is maintained.

Referring to FIG. 7, the engagement means 8 for mounting the intermediate portion of the other side edge flange 14 of the pillar garnish 1 to the pillar outer surface 20 has a projection 8a of synthetic resin provided on the pillar outer surface 20 side that mates and fastens in a mating hole 80 in a receiving member 8b of synthetic resin provided on the back surface side of the pillar garnish 1.

Projection 8a is a square column-shaped projection that is erected upward from a base plate 81, and that has a pawl 82 at the tip thereof. The projection 8a is mounted by pressing and fastening a plurality of fastening legs 83 into mounting holes in the pillar outer surface 20. The erection attitude of the projection 8a is set to be substantially parallel with the direction of the pressing of the pillar garnish 1 described above.

The receiving member 8b, which is a synthetic resin panel extending in the width direction across the two side edge flanges 11 and 14, fastens and secures engagement parts 84 and 85 provided in the two end edges thereof, respectively, to the two side edge flanges 11 and 14. In the receiving member 8b, the mating hole 80 is formed so as to correspond to the projection 8a, and, in the mating hole 80 there is a pawl receiver exhibiting an elasticity responsive to the pawl 82 of the projection 8a, in the circumferential edge thereof. Also, the engagement means 8, by the pressing described above, presses the projection 8a into the mating hole 80 of the receiving member 8b, and fastens the pawl 82 of the projection 8a in the pawl receiver of the mating hole 80.

Based on the mounting structure in this embodiment, the upper end and lower end, respectively, of the pillar garnish 1 are fastened by the retainers 3 and 3a, which integrally fasten the side edge flanges 11 and 14, wherefore the overall pulling rigidity of the pillar garnish 1 can be strengthened, and mounting stability can be enhanced. In particular, even if a passenger places a hand on the pillar garnish 1 when entering or exiting the vehicle, with the upper surface part 30 of the retainer 3 proximate to and facing the back surface of the pillar garnish 1 acting as a support, flexure of the pillar garnish 1 is suppressed, loosening or wobbling of the fasteners and the pillar 2 is prevented from occurring, and, thereby, the pillar garnish 1 is prevented from inadvertently coming off.

If loosening or wobble tend to occur in the fasteners between the pillar garnish 1 and the pillar 2, due to the wind pressure in effect when the vehicle is traveling at high speed, for example, and there is a danger that the pillar garnish 1 will be pushed up from below and be ripped away from the pillar 2, because the pin 63 in the latching piece 60 at the lower end of the pillar garnish 1 latches in the inner end of the channel 53 in the hook part 50 of the retainer 3a (FIG. 6), separation of the pillar garnish 1 due to wind pressure is prevented.

When the pillar garnish 1 is mounted to the pillar outer surface 20, by pressing the pillar garnish 1 in the same direction toward the pillar outer surface 20 side, fastening can be affected in the upper and lower retainers 3 and 3a and the engagement means 7 and 8, wherefore the mounting operation is easy.

When replacing the windshield G, it is necessary to remove the pillar garnish 1 from the pillar 2. In such cases, by an operation in which the side edge flange 14 side of the pillar garnish 1 is pried in the direction of lift-up from the pillar outer surface 20 (direction of the arrow in FIG. 2) using a tool such as a flat screwdriver or the like, the engagement between the elastic fastening pieces 37 of the retainers 3 and 3a and the engagement means 8 is released and one side of the pillar garnish 1 can be pulled away as indicated by the phantom lines in FIG. 2 and FIG. 7. After that, by moving the pillar garnish 1 upward or downward along the longitudinal dimension thereof, and releasing the engagements between the fastening projections 35 and 36 of the engagement means 7 and retainers 3 and 3a, on the one hand, and the engagement holes 12 of the pillar garnish 1, on the other, the pillar garnish 1 can easily be removed.

In this embodiment a hook part 50 is provided in the retainer 3a at the lower end, but a retainer having no hook part 50 may also be used. It is preferable that a hook part 50 be provided, however, in the interest of preventing inadvertent separation. In this embodiment, moreover, the present invention is applied to a mounting structure for a metal sheet pillar garnish, but that poses no limitation, and the present invention may also be applied to a synthetic resin pillar garnish.

While preferred embodiments of the invention have been shown and described, changes can be made without departing from the principles and spirit of the invention, the scope of which is defined in accompanying claims.

What is claimed is:

1. A vehicle pillar garnish mounting structure for fastening a pillar garnish to an outer surface of a vehicle pillar, by engagement means, wherein:
side edge flanges are formed at two side edges of said pillar garnish, spaced in a width dimension of said pillar garnish, extending toward the pillar;
a retainer is secured to an outer surface of the pillar, extending between two sides of the pillar in a width dimension, serving as said engagement means, and comprising engagement parts on two sides of said retainer for fastening to said two side edge flanges of said pillar garnish, respectively; and
the side edge flanges of said pillar garnish are engaged in the engagement parts.

2. The vehicle pillar garnish mounting structure according to claim 1, wherein said retainer is configured by a block having a substantially U-shaped cross section, with an upper surface part facing a back surface of said pillar garnish and side surface parts extending toward the pillar outer surface.

3. The vehicle pillar garnish mounting structure according to claim 2, wherein, on one side surface part of said retainer, one of said engagement parts comprises a fastening projection that mates in an engagement hole formed in one side edge flange of said pillar garnish, and an elastic clamping piece that extends from said one side surface part, for clamping one side edge flange of said pillar garnish with said one side surface part, and
in the other side surface part of said retainer, one of said engagement parts comprises an elastic fastening piece, extending downward and outward from the other side surface part, in a tongue shape, with a protruding end that engages with an edge of the other side edge flange of said pillar garnish.

4. The vehicle pillar garnish mounting structure according to claim 3, wherein said fastening projection has a pawl shape, oriented downward and outward from said one side surface part, said elastic clamping piece has a substantially L-shape, extending outward from said one side surface part and extending upward along said one side surface part, and said fastening projection and said elastic clamping piece are deployed in parallel so as to be mutually adjacent to said one side surface part, and
said elastic fastening piece has a structure that extends in cut-and-raised form from said other side surface part.

5. The vehicle pillar garnish mounting structure according to claim 1, wherein said retainer has a hook unit that extends from a lower end thereof and that has an opening leading to a channel closed at an inner end, and
at a position corresponding to said hook, a latching piece extends from a back surface of said pillar garnish, and has a pin laterally oriented along the width of said retainer, with protruding ends received in said channel in said retainer to latch in said inner end of said channel.

6. The vehicle garnish mounting structure according to claim 1, wherein there are two retainers for fastening an upper portion and a lower portion, respectively, of said pillar garnish to the outer surface of the vehicle pillar.

7. The vehicle pillar garnish mounting structure according to claim 6, wherein the retainer for fastening the lower portion of the pillar garnish has a hook unit that extends from a lower end thereof, and the pillar garnish has a latching piece that cooperates with the hook unit to secure the pillar garnish to the hook unit.
